(19) United States
(12) Patent Application Publication
(10) Pub. No.: US 2026/0212458 A1
(43) Pub. Date: Jul. 23, 2026

(54) UNIVERSAL IMAGE RESTORATION

(71) Applicant: Google LLC, Mountain View, CA (US)

(72) Inventors: Mauricio Delbracio, Sunnyvale, CA (US); Peyman Milanfar, Menlo Park, CA (US); Keren Ye, Mountain View, CA (US); Mo Zhou, Baltimore, MD (US); Hossein Talebi, San Jose, CA (US)

(21) Appl. No.: 19/452,048

(22) Filed: Jan. 16, 2026

Related U.S. Application Data
(60) Provisional application No. 63/746,841, filed on Jan. 17, 2025.

(51) Int. Cl. G06T 5/60; G06T 5/70

(52) U.S. Cl. CPC G06T 5/60; G06T 5/70; G06T 2207/20084

(57) ABSTRACT

Methods, systems, and apparatus, including computer programs encoded on computer storage media, for performing image restoration using a diffusion neural network on images that have different mixtures of degradations.

### CROSS-REFERENCE TO RELATED APPLICATIONS

This application claims priority to U.S. Provisional Application No. 63/746,841, filed on Jan. 17, 2025. The disclosure of the prior application is considered part of and is incorporated by reference in its entirety in the disclosure of this application.

### BACKGROUND

This specification relates to image restoration.

Image restoration is the process of improving or reconstructing an image that has been degraded or corrupted. The goal is to restore the image to its original state or to create the most accurate representation of the original scene.

Image restoration may be performed using neural networks.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, e.g., the next hidden layer or the output layer. Each layer of the network generates an output from a received input in accordance with current values of a respective set of parameters.

### SUMMARY

This specification describes an image restoration system implemented as computer programs on one or more computers in one or more locations that uses a diffusion neural network to perform image restoration.

The subject matter described in this specification can be implemented in particular embodiments so as to realize one or more of the following advantages.

The specification describes an image restoration system that can effectively address real-world image degradations that are too complex to be explicitly modeled by existing image restoration systems that are configured to model only a limited number of types of image degradation. By performing a reverse diffusion process on a degraded image based on a weighted combination of denoising outputs generated by a diffusion neural network, where the weights associated with the denoising outputs can be flexibly and adaptively adjusted based on the actual degraded image, the described system can generate a restored image that has improved image clarity and detail compared to a degraded image, and further relative to other restored images that could be generated by baseline image restoration systems from the degraded image according to some measure of image quality.

The specification also describes techniques for training the diffusion neural network simultaneously across a plurality of image restoration tasks that address different types of degradation, e.g., on different ones of a super resolution task, a motion deblurring task, a defocus deblurring task, and a denoising task. Combined with dynamic weight combination at inference time, the in-domain knowledge learned by the diffusion neural network with respect to each of the plurality of image restoration tasks can be transferred to enable the described system to robustly perform in-the-wild image restoration, e.g., to restore the degraded image even in cases where the one or more types of degradation that actually resulted in the degraded image are different from those on which the diffusion neural network has been trained. The dynamic weight combination techniques can be used to improve individual pipelines for specific image restoration tasks without having to retrain the diffusion neural network as a whole. For example, an image restoration system as described can implement an improved super resolution pipeline without affecting pipelines related to denoising.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system and an example image restoration system.

FIG. 2 is an example illustration of operations to train a diffusion neural network.

FIG. 3 is an example illustration of operations to perform image restoration using a diffusion neural network.

FIG. 4 is a flow diagram of an example process for performing image restoration using a diffusion neural network.

FIG. 5 is a flow diagram of an example process for training a diffusion neural network.

Like reference numbers and designations in the various drawings indicate like elements.

### DETAILED DESCRIPTION

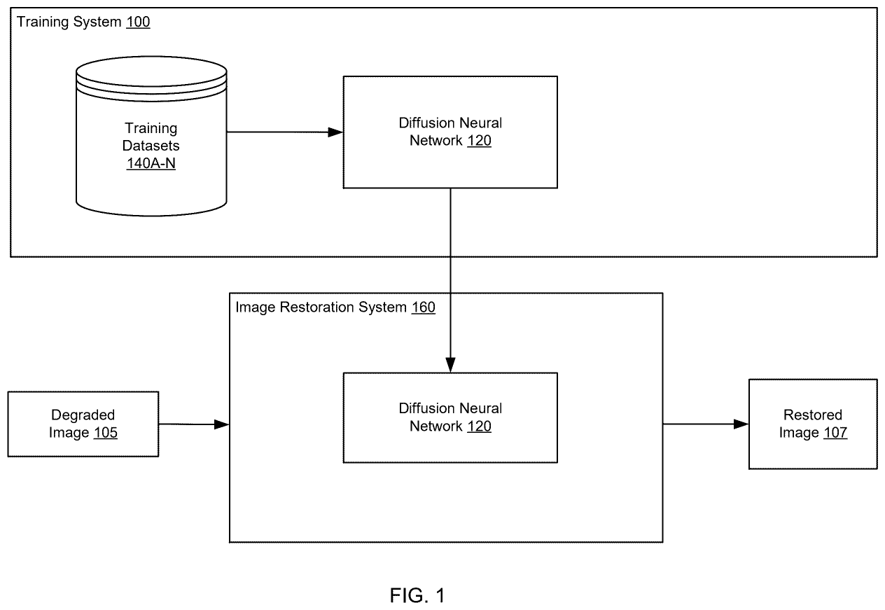

FIG. 1 shows an example training system 100 and an example image restoration system 150.

The training system 100 and the image restoration system 150 are examples of a system implemented as computer programs on one or more computers in one or more locations, in which the systems, components, and techniques described below can be implemented.

The training system 100 trains a diffusion neural network 120 across a plurality of training datasets 140A-N. The plurality of training datasets correspond respectively to a plurality of image restoration tasks.

After the training, the image restoration system 150 can use the trained diffusion neural network 120 to perform image restoration.

For example, the image restoration system 150 can be in data communication with or can be part of an image editing application, a camera application, an album application, or another application for image editing. Such an application can run locally on an electronic device, remotely on the one or more computers in the one or more locations, or both locally and remotely. A user of the electronic device can use the application to edit images.

The image restoration system 150 receives a degraded image 105 as input and generates a restored image 107 as output by executing a reverse diffusion process using the diffusion neural network 120.

For example, the degraded image 105 can be received by the image restoration system 150 as an upload from a user of the system. As another example, the degraded image 105 can be received by the image restoration system 150 from a storage device that is accessible by the system.

The restored image 107 removes one or more types of image degradation from the degraded image 105. The restored image 107 has improved image clarity and detail compared to the degraded image 105.

The diffusion neural network 120 can be any appropriate conditional diffusion neural network that enables the diffusion neural network 120 to perform a reverse diffusion process in a latent space, e.g., in a latent space that is lower-dimensional than an outer space, e.g., a pixel space.

That is, the representations operated on by the diffusion neural network are latent representations and the values in the representations are learned, latent values, e.g., rather than color values, e.g., rather than RGB values or another color encoding scheme.

Examples of such diffusion neural networks include those described in Zhao, Yang, et al. Mobilediffusion: Instant text-to-image generation on mobile devices. European Conference on Computer Vision. Cham: Springer Nature Switzerland, 2024, and Baldridge, Jason, et al. Imagen 3. arXiv preprint arXiv:2408.07009 (2024).

This specification describes the neural network used by the image restoration system 150 being a diffusion neural network, and the data processing process executed using the neural network being a reverse diffusion process.

More generally, however, the neural network can be any appropriate generative neural network that can map a conditioning input to an output data item, e.g., a denoising neural network, an auto-regressive generative neural network, a non-auto-regressive masked token generation neural network, a normalizing flows model, the generator of a generative adversarial neural network, and so on.

That is, the diffusion neural network mentioned in this specification should be understood to refer to any type of generative neural network that can be used to denoise a noisy representation of a data item using any of a variety of denoising frameworks, e.g., reverse diffusion, unmasking, flow matching, multi-step consistency, and so on, and the reverse diffusion process can refer to any appropriate denoising process that can map the noisy representation of an image to a final image.

Although the discussion herein refers to one diffusion neural network, in some examples the training and inference described can be performed on a system including multiple neural networks or other types of machine learning models.

For example, the diffusion neural network 120 can be associated with or include an encoder neural network to encode images into the latent space and a decoder neural network that receives an input that includes a latent representation of an image and decodes the latent representation to reconstruct the image. For example, the encoder and decoder can have been trained jointly on an image reconstruction objective, e.g., a VAE objective, a VQ-GAN objective, or a VQ-VAE objective.

By virtue of the multi-task training techniques adopted by the training system 100 as will be described further below, the trained diffusion neural network 120 can be used to perform in-the-wild image restoration, e.g., to restore the degraded image even in cases where the one or more types of degradation that resulted in the degraded image are different from those on which the diffusion neural network 120 has been trained.

This generalizability gives the image restoration system 150 the flexibility to address complex degradations that include arbitrary mixtures of multiple real-world degradations.

For example, the types of image degradation can include resolution degradation.

In this example, a degraded image can be an input image that has a lower resolution, while a restored image can be an output image that has a higher resolution than the input image. An image restoration task performed to generate the restored image with a higher resolution than the input image can be referred to as a super resolution task.

As another example, the types of image degradation can include motion blur.

Motion blur is a visual effect that occurs when a moving object is captured by a camera or other recording device while the object is still moving. The motion blur in an image of a moving object can appear as a blur or streaking effect. In this example, a degraded image can be an input image that has a greater amount of motion blur, while a restored image can be an output image that has a smaller amount of motion blur than the input image. For example, the degree to which a moving object appears blurred in the output image is less than the degree to which a corresponding moving object appears blurred in the input image. An image restoration task performed to generate the restored image with less motion blur than the input image can be referred to as a motion deblurring task.

As another example, the types of image degradation can include defocus blur.

Defocus blur is a loss of sharpness in an image that occurs when an object is not positioned at the camera's focal plane, causing light rays from that object to spread out on the image sensor, resulting in a blurred appearance. In this example, a degraded image can be an input image that has a greater amount of defocus blur, while a restored image can be an output image that has a smaller amount of defocus blur than the input image. For example, the degree to which an object appears blurred in the output image is less than the degree to which a corresponding object appears blurred in the input image. An image restoration task performed to generate the restored image with less defocus blur than the input image can be referred to as a defocus deblurring task.

As another example, the types of image degradation can include noise, where less noise indicates a higher quality.

Image noise is a random variation in an image's brightness or color information that can for example appear as grainy or speckled artifacts. In this example, a degraded image can be an input image that has a greater amount of noise, while a restored image can be an output image that has a smaller amount of noise than the input image. An image restoration task performed to generate the restored image with less noise than the input image can be referred to as a denoising task.

As another example, the one or more types of image degradation that can be removed from an input image can include two or more of the types of the degradations mentioned above, and possibly other types of degradation that can be applied to the input image.

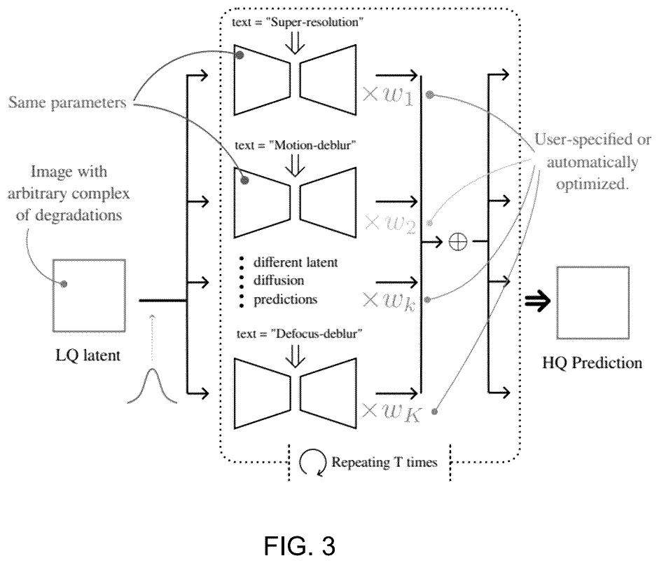

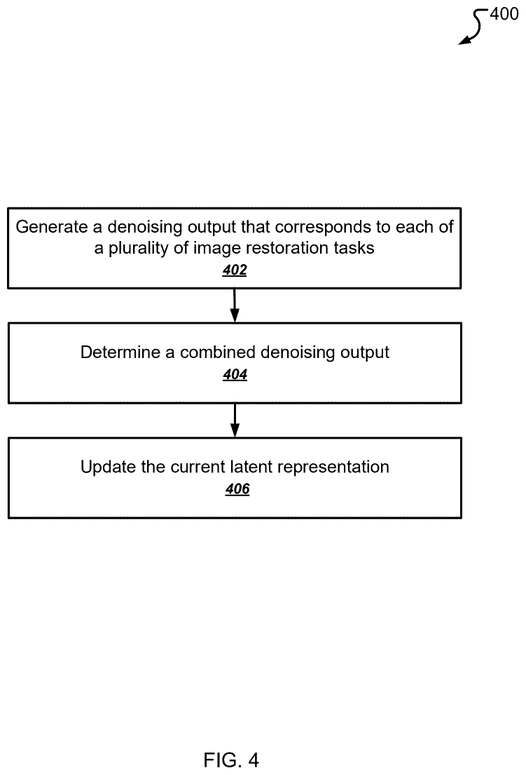

As will be described further below with reference to FIGS. 3-4, to achieve in-the-wild image restoration, the image restoration system 150 performs the reverse diffusion process on the degraded image 105 based on a weighted combination of denoising outputs generated by the diffusion neural network 120, where the weights associated with the denoising outputs can be flexibly and adaptively adjusted. That is, the image restoration system 150 can use different weights for the same or different degraded images.

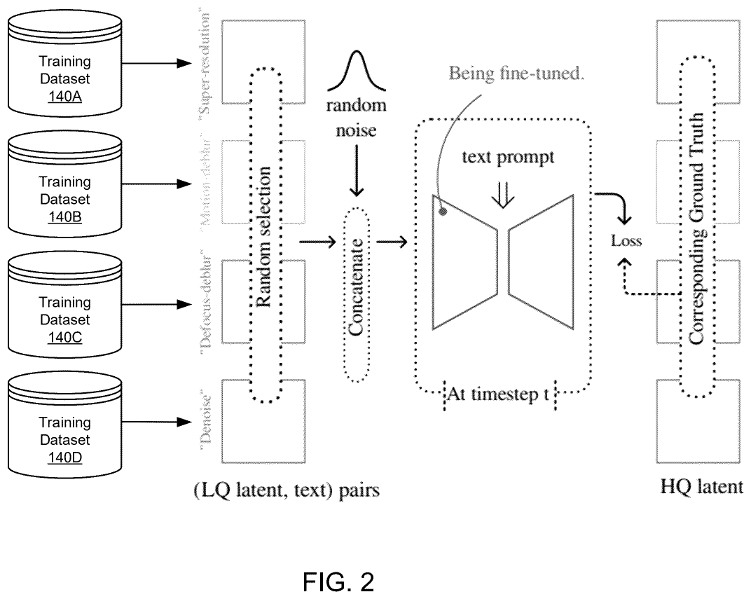

FIG. 2 is an example illustration of operations performed by the training system 100 to train the diffusion neural network 120.

The training system 100 trains the diffusion neural network 120 across a plurality of training datasets 140A-N. The plurality of training datasets correspond respectively to a plurality of image restoration tasks.

In the example of FIG. 2, the training system 100 trains the diffusion neural network 120 on a total of four training datasets 140A-D that correspond respectively to four different image restoration tasks: a first training dataset 140A corresponding to a super resolution task, a second training dataset 140B corresponding to a motion deblurring task, a third training dataset 140C corresponding to a defocus deblurring task, and a fourth training dataset 140D corresponding to a denoising task.

In other examples, the training system 100 can train the diffusion neural network 120 on more, e.g., five, or fewer, e.g., two, training datasets that correspond respectively to more or fewer image restoration tasks. In yet other examples, the training system 100 can train the diffusion neural network 120 on more than one training dataset per image restoration task, e.g., multiple different training datasets for a motion deblurring task, multiple different training datasets for a denoising task, and so on.

For each image restoration task, a training dataset that corresponds to the image restoration task includes a plurality of training tuples. Each training tuple includes an input image, an output image, and a text prompt that identifies the image restoration task. Other data structures can also be used to represent input images, output images, text prompts, and any other data included in the training dataset. Other data structures can include vectors, matrices, tensors, and so on.

The input image has a type of degradation, which is specific to the image restoration task, relative to the output image included in the same training tuple.

To identify the image restoration task, the text prompt can include natural language text that describes the image restoration task, e.g., “motion deblur,” or the type of the degradation that resulted in the input image, e.g., “motion blur.”

In addition or alternatively, the text prompt can include an identifier corresponding to the image restoration task. The identifier can be an alphabetical, numeric, alphanumeric, symbolic, or another type of identifier.

The training system 100 repeatedly performs the following operations at each of a plurality of training steps to fine-tune, i.e., further train, an already-trained diffusion neural network 120. In other words, prior to being trained by the training system 100, the training system 100 or another training system has trained the diffusion neural network 120 on a different objective. In general, the diffusion neural network can have been trained conventionally, using any diffusion model objective. As one example, the diffusion neural network can have been trained on a set of training data items on a diffusion score matching objective or a variant thereof.

By repeatedly performing the following operations, the training system 100 can determine the fine-tuned values of parameters of the diffusion neural network 120 beginning from their pre-trained values determined as a result of the pre-training.

To train the diffusion neural network 120 on different image restoration tasks simultaneously, the training system 100 obtains a batch of training tuples from across two or more of the training datasets 140A-D. Thus, each batch of training tuples might include training tuples obtained from two or more of the training datasets 140A-D.

In some implementations, within each training dataset, the training system 100 obtains one or more training tuples through random sampling. In some implementations, the training system 100 obtains the same number of training tuples from each training dataset whereas, in other implementations, the training system 100 obtains different numbers of training tuples from different training datasets, e.g., in accordance with respective weights assigned to the training datasets.

For each training tuple in the batch, the training system 100 processes a diffusion input using the diffusion neural network 120 to generate a denoising output.

The diffusion input includes a noisy latent representation of the input image included in the training tuple.

The noisy latent representation is generated by encoding the input image using the encoder neural network into a latent representation that resides in the latent space, and then adding noise to the latent representation. The training system 100 samples a time step from a possible space of time steps, and the noise level of the added noise depends on the time step. FIG. 2 refers to the noisy latent representation as a “high-quality (HQ) latent.”

The diffusion input includes a latent low-quality (LQ) conditioning input.

The latent LQ conditioning input is generated by encoding a low-quality version of the input image using the encoder neural network into a latent representation of the low-quality version of the input image that resides in the latent space.

In some implementations, the low-quality version of the input image is included in the training dataset. For example, each training tuple can include a pair of high-quality and low-quality input images, an output image, and a text prompt.

In other implementations, where the low-quality version of the input image is not included in the training dataset, the training system 100 executes a degradation pipeline to generate the low-quality version of the input image.

In some of those implementations, the training system 100 executes different degradation pipelines for different types of the degradation. Thus, how the low-quality version of the input image is generated may vary depending on its type of the degradation.

For example, where the type of image degradation is resolution, the training system 100 can execute an image resolution degradation pipeline that applies a sequence of synthetic distortions, e.g., Gaussian blur, Gaussian or Poisson noise, resizing, and compression, on an input image to generate a low-resolution version of the input image as the low-quality version of the input image.

As another example, where the type of image degradation is motion blur, the training system 100 can simulate camera shake blur by applying random blur kernels of varying intensities and sizes to individual objects within an input image to generate a blurred version of the input image as the low-quality version of the input image. Additional examples of degradation operations include adding lens blur (e.g., using Gaussian blur kernels), adding shot noise, adding read-out noise, and compression.

The diffusion input includes the text prompt included in the training tuple. FIG. 2 refers to the latent LQ conditioning input and the text prompt as a “(LQ latent, text) pair.”

The diffusion input can include a time index that identifies the time step sampled by the training system 100. As mentioned previously the noise level of the noisy latent representation depends on the time step. Alternatively, the diffusion input can include an encoded representation of the time index that is generated by a time index encoder neural network. The time index encoder is configured to receive an input that includes the time index and to process the input to generate the encoded representation of the time index.

In some implementations, the denoising output specifies an estimated (predicted) noise included in the noisy latent representation as computed by the diffusion neural network 120 from processing the diffusion input.

In some other implementations, the denoising output is an estimate of the final latent representation given the current latent representation, i.e., an estimate of the latent representation of the restored image that would result from removing the noise component of the current latent representation.

In yet other implementations, the training system 100 parametrizes the denoising output differently, e.g., using a v-parameterization (Salimans, Tim, and Jonathan Ho. ‘“Progressive distillation for fast sampling of diffusion models.” arXiv preprint arXiv:2202.00512 (2022), at section 4; Appendix D) or another appropriate parameterization.

The training system 100 trains the diffusion neural network 120 to update values of the parameters of the diffusion neural network 120 based on optimizing a fine-tuning objective function that evaluates, for each input tuple in the batch, a difference between the denoising output and a target denoising output, e.g., a difference between (i) the estimated noise included in the noisy latent representation and (i) the actual (ground truth) noise added to the latent representation of the input image.

For example, when the denoising output specifies an estimated noise, the fine-tuning objective function can be:

$$L ( θ ) = {𝔼}_{t , {x}_{0} , ϵ \sim 𝒩 ( 0 , 1 )} [ {‖ ϵ - {ϵ}_{θ} ( {z}_{t} , {z}_{LQ} , s ) ‖}^{2} ]$$

where ∈ represents the actual noise added to the latent representation, ∈_{θ}(·) represents the estimated noise included in the noisy latent representation as computed by the diffusion neural network, θ represents the parameters of the diffusion neural network, x₀ represents the input image, t represents the time step, zₜ represents the noisy latent representation of the input image, z_{LQ} represents the latent LQ conditioning input, and s represents the text prompt.

To enable the diffusion neural network 120 to restore images without explicit instructions (blind restoration), some implementations of the training system 100 drop the text prompts at a predetermined rate, e.g., 0.05, 0.1, or 0.2, during training. That is, the term in the fine-tuning objective function representing the estimated noise as computed by the diffusion neural network becomes ∈_{θ}( [symbol] , [symbol] , Ø) This allows the diffusion neural network 120 to learn a generalized restoration capability even when the specific degradation type is unknown.

FIG. 3 is an example illustration of operations performed by the image restoration system 150 to perform image restoration using the diffusion neural network 120.

The image restoration system 150 performs the following operations on a degraded image to generate a restored image.

The image restoration system 150 initializes a latent representation of the restored image, i.e., generates an initial latent representation of the restored image, by sampling each value in the latent representation from a corresponding noise distribution, e.g., a Gaussian distribution or a different noise distribution.

The image restoration system 150 executes a reverse diffusion process across a plurality of updating iterations using the diffusion neural network 120 to iteratively update, i.e., denoise, the initial latent representation to generate a final latent representation.

At each of the plurality of updating iterations, and for each of a plurality of image restoration tasks, the image restoration system 150 processes a diffusion input for the updating iteration that corresponds to the image restoration task using the diffusion neural network 120 to generate a denoising output for the updating iteration that corresponds to the image restoration task.

That is, at each updating iteration, the image restoration system 150 uses the same diffusion neural network 120 and in accordance with the same values of the parameters of the diffusion neural network to generate a plurality of different denoising outputs that correspond respectively to the plurality of different image restoration tasks.

As mentioned previously the trained diffusion neural network 120 can be used to perform in-the-wild image restoration. Thus, the plurality of image restoration tasks may or may not be same as, e.g., may include additional tasks than, the image restoration tasks mentioned with reference to FIG. 2.

For each image restoration task, the diffusion input at a given updating iteration includes a current latent representation.

When the given updating iteration is the first (initial) updating iteration in the plurality of updating iterations, the current latent representation is the initial latent representation. For any subsequent updating iteration in the plurality of updating iterations, the current latent representation is an updated latent representation that has been generated in a preceding updating iteration.

For each image restoration task, the diffusion input at the given updating iteration includes a latent representation of the degraded image. FIG. 2 refers to the latent representation of the degraded image as a “LQ latent.”

The latent representation of the degraded image may vary from one image restoration task to another (although it generally remains fixed across the plurality of updating iterations for each image restoration task).

For some image restoration tasks, the latent representation of the degraded image can be generated by encoding the degraded image using the encoder neural network.

For some other image restoration tasks, the latent representation of the degraded image can be generated by down-sampling the degraded image by a predetermined factor, e.g., two, four, or eight, followed by resizing, e.g., through bicubic-upscaling, the down-sampled image back to the original resolution of the degraded image, and followed by encoding the resized image using the encoder neural network. Such a latent representation enables the diffusion neural network 120 encourages the diffusion neural network 120 to generate more details.

For each image restoration task, the diffusion input at the given updating iteration includes a corresponding text prompt, e.g., natural language text or other identifier, that identifies the image restoration task.

For each image restoration task, the diffusion input at the given updating iteration includes can also include a time index (or an encoded representation of the time index) that identifies a time step corresponding to the given updating iteration.

For each image restoration task, the denoising output at the given updating iteration specifies an estimated noise included in the current latent representation as computed by the diffusion neural network 120 from processing the diffusion input at the given updating iteration.

The image restoration system 150 determines a combined denoising output for the given updating iteration based on the plurality of denoising outputs generated by using the diffusion neural network 120 that correspond respectively to the plurality of image restoration tasks.

In some implementations, as illustrated in FIG. 3, the combined denoising output for the given updating iteration can be determined as a weighted combination, e.g., a weighted sum or a weighted average. For each of the plurality of restoration tasks, the denoising output that corresponds to the image restoration task is weighted in the weighted combination by a weight that is associated with the image restoration task.

For example, the combined denoising output can be generated as:

$${\tilde{ϵ}}_{θ} ( {z}_{t} , {z}_{LQ} ; w ) = {{\sum }_{k = 1}}^{K} {w}_{k} \cdot {ϵ}_{θ} ( {z}_{t} , {z}_{LQ} , {s}_{k} )$$

where wₖ represents the weight assigned to an image restoration task (e.g., how much “motion deblurring” is needed). The weights may sum to 1. A few example ways to obtain the weights are described further below with reference to FIG. 4. k represents the index of an image restoration task. ∈_{θ}(·) represents the estimated noise included in the current latent representation as computed by the diffusion neural network, θ represents the parameters of the diffusion neural network, zₜ represents the current latent representation, z_{LQ} represents the latent representation of the degraded image, and sₖ represents the text prompt that identifies the image restoration task.

The image restoration system 150 updates the current latent representation using the combined denoising output to generate an updated latent representation.

In some implementations, the image restoration system 150 applies a diffusion sampler, e.g., the DDPM (Denoising Diffusion Probabilistic Model) sampler, the DDIM (Denoising Diffusion Implicit Model) sampler or another appropriate sampler. For example, to generate the updated latent representation, the diffusion sampler can use at least the combined denoising output to remove a noise component from the current latent representation.

Optionally, as will be described further below with reference to FIG. 4, when classifier-free guidance is used, the image restoration system 150 uses an additional, combined denoising output to update the current latent representation. Such a combined denoising output is generated by the diffusion neural network 120 without processing the latent representation of the degraded image, the corresponding text prompt, or both.

After the last updating iteration, the image restoration system 150 processes the updated latent representation generated in the last updating iteration using the decoder neural network to map it to the restored image. FIG. 2 refers to the updated latent representation generated in the last updating iteration as a “HQ prediction.”

FIG. 4 is a flow diagram of an example process 400 for performing image restoration on a degraded image using a diffusion neural network to generate a restored image from the degraded image. The restored image removes one or more types of image degradation from the degraded image. The restored image has improved image clarity and detail compared to the degraded image.

For convenience, the process 400 will be described as being performed by a system of one or more computers located in one or more locations. For example, an image restoration system, e.g., the image restoration system 150 depicted in FIG. 1, appropriately programmed in accordance with this specification, can perform the process 400.

To perform image restoration a degraded image, the system initializes a latent representation of the restored image, i.e., generates an initial latent representation of the restored image, and then updates the initial latent representation of the restored image by executing a reverse diffusion process across a plurality of updating iterations by using the diffusion neural network.

Each update iteration corresponds to an iteration of process 400. Thus, the system updates the initial latent representation by repeatedly performing iteration of process 400 until a termination criterion is satisfied, e.g., a predetermined number of iterations of process 400 has been performed.

For each of a plurality of image restoration tasks, the system processes a diffusion input for the updating iteration that corresponds to the image restoration task using the diffusion neural network to generate a denoising output for the updating iteration that corresponds to the image restoration task (step 402).

For each image restoration task, the diffusion input at the updating iteration includes (i) a current latent representation, (ii) a latent representation of the degraded image, and (iii) a corresponding text prompt that identifies the image restoration task, e.g., that includes natural language text that describes the image restoration task, or another identifier that identifies the image restoration task. In other words, the diffusion input is described as corresponding to the image restoration task because it includes the corresponding text prompt that identifies the image restoration task.

For each image restoration task, the diffusion input at the given updating iteration includes can also include a time index (or an encoded representation of the time index) that identifies a time step corresponding to the given updating iteration.

For each image restoration task, in some implementations, the denoising output at the updating iteration specifies an estimated noise included in the current latent representation as computed by the diffusion neural network from processing the diffusion input at the updating iteration.

The diffusion neural network can be conditioned on the diffusion input in any of a variety of ways when generating the denoising output.

For example, the diffusion neural network can include one or more cross-attention layers that cross attend into the current latent representation, the latent representation of the degraded image, and an encoded representation of the text prompt.

As another example, the diffusion neural network can include one or more other types of neural network layers that are conditioned on these representations. Examples of such layers include Feature-wise Linear Modulation (FILM) layers, layers with conditional gated activation functions, and so on.

In either example, the current latent representation can be concatenated with the latent representation of the degraded image, and the concatenation is processed by layers of the diffusion neural network, allowing the diffusion neural network to better preserve pixel structure from the degraded image.

The system determines a combined denoising output for the updating iteration based on the denoising outputs generated by using the diffusion neural network that correspond respectively to the plurality of image restoration tasks (step 404).

In some implementations, the combined denoising output for the given updating iteration can be determined as a weighted combination of the denoising outputs. For each of the plurality of restoration tasks, the denoising output that corresponds to the image restoration task is weighted in the weighted combination by a weight that is associated with the image restoration task. In some cases, a weight associated with an image restoration task may be zero, indicating that the degraded image may not have the type of degradation corresponding to the image restoration task.

Different weights may be associated with different image restoration tasks. There are many ways in which the weights can be determined.

For example, the weights can be predetermined. For example, the system can receive, e.g., from a user or another system that provided the degraded image, an input that, for each of the plurality of image restoration tasks, defines the weight that is associated the image restoration task. In this example, the weights may be fixed for different degraded images.

As another example, the weights can be automatically determined by the system by performing a grid search over possible weight combinations to determine the respective weight associated with each image restoration task. In this example, the weights may be different for different degraded images.

Specifically, for the degraded image, the system can generate initial restored images in accordance with the different weight combinations defined in a grid defining possible weight combinations, determine a quality score for each initial restored image, and then select the final restored image (and corresponding weights) that achieved the highest quality score.

In the grid, the weights for each image restoration task can be selected from a predetermined range, e.g., [−0.2, 1.2], with a predetermined step size (interval), e.g., an interval of 0.2. The sum of all weights may equal 1. In some implementations, at most one negative weight (−0.2) may be allowed.

In some implementations, the quality score for an initial restored image can be determined by processing the initial restored image using an image quality assessment model. An example of a suitable image quality assessment model is the MUSIQ model described in Ke, Junjie, et al. “Musiq: Multi-scale image quality transformer.” Proceedings of the IEEE/CVF international conference on computer vision. 2021.

By adjusting the weights, the system can tailor the image restoration to the specific defects of the degraded image. For example, restoring a blurry night photo might need a high weight for the motion deblurring task but a lower weight for the denoising task. As another example, restoring a low-resolution photo with motion blur might need a high weight for both super-resolution and motion deblurring tasks.

As yet another example, the weights can be determined by the system based on a classification output generated by an image degradation classification model from processing the degraded image.

The image degradation classification model can be configured to process an input that includes the degraded image to generate an output that includes, for each of a plurality of degradation types, a respective score that represents a likelihood that the degraded image includes a degradation of the type.

The image degradation classification model can be any of a variety of neural networks. For example, the image degradation classification model can be a multi-modal language model neural network and the input to the neural network can also include an instruction to detect a value of the target property of the candidate data item.

That is, the system can prompt a general-purpose large scale multi-modal language model to cause the language model to generate the classification output. Examples of such neural networks include those described in Comanici, Gheorghe, et al. Gemini 2.5: Pushing the frontier with advanced reasoning, multimodality, long context, and next generation agentic capabilities. arXiv preprint arXiv:2507.06261 (2025), Gemma Team, et al. Gemma 3 Technical Report arXiv preprint arXiv:2503.19786 (2025), and PaliGemma.

This flexibility to combine different weights at inference allows the system to improve the quality of the restored image relative to restored images that would be generated by baseline image restoration systems, which either focus on a single image restoration task or assign fixed weights to multiple tasks, from the same degraded image.

The system updates the current latent representation using the combined denoising output to generate an updated latent representation (step 406).

In some implementations, the system does this by applying a diffusion sampler. For example, to generate the updated latent representation, the diffusion sampler can use the combined denoising output to remove a noise component from the current latent representation.

In some implementations, the system uses classifier-free guidance during at least some of the iterations of process 400.

At an iteration where classifier-free guidance is used, at step 402, the system generates two denoising outputs for each image restoration task: a first (fully conditional) denoising output that is generated as described above, and a second (partially conditional or unconditional) denoising output that is generated by using the diffusion neural network by processing a diffusion input that excludes the latent representation of the degraded image, the corresponding text prompt, or both.

At step 404, the system then determines two combined denoising outputs for the updating iteration: a first (fully conditional) combined denoising output that is generated based on the first denoising outputs that correspond respectively to the plurality of image restoration tasks, and a second (partially conditional or unconditional) combined denoising output that is generated based on the second denoising outputs that correspond respectively to the plurality of image restoration tasks.

At step 406, the system updates the current latent representation using the two combined denoising outputs to generate the updated latent representation. For example, the system can generate an adjusted denoising output by computing a sum of the second combined denoising output and a product of a predetermined guidance weight and a difference between the first combined denoising output and the second combined denoising output, and then applying the diffusion sampler to use the adjusted denoising output to remove a noise component from the current latent representation.

After the last iteration of process 400, the system processes the updated latent representation generated in the last iteration of process 400 using the decoder neural network to map it to the restored image. That is, the restored image is generated from the updated latent representation that is generated in the last iteration of process 400.

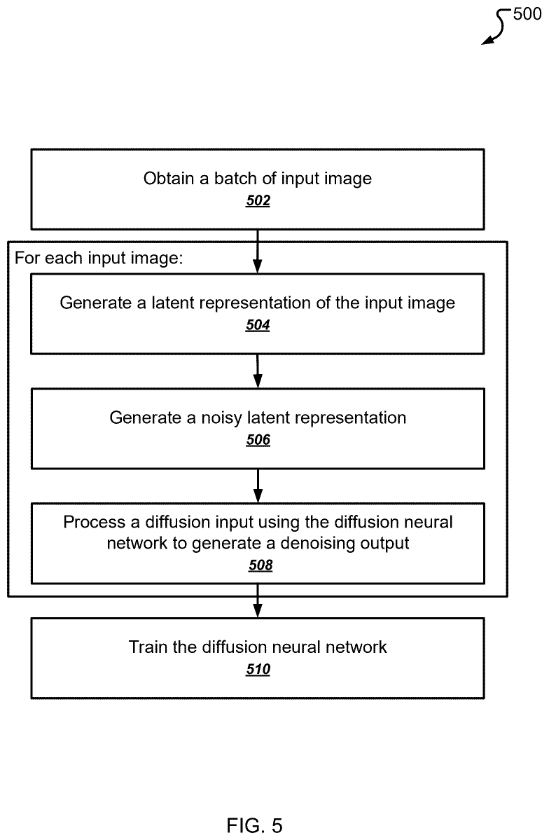

FIG. 5 is a flow diagram of an example process 500 for training a diffusion neural network. For convenience, the process 500 will be described as being performed by a system of one or more computers located in one or more locations. For example, a training system, e.g., the training system 100 depicted in FIG. 1, appropriately programmed in accordance with this specification, can perform the process 500.

The system obtains, through sampling, a batch of input images from across two or more of a plurality of training datasets that correspond respectively to a plurality of image restoration tasks (step 502).

For each of the plurality of image restoration tasks, the training dataset that corresponds to the image restoration task includes a plurality of input images and an output image associated with each of the plurality of input images. Each input image has an image restoration task-specific degradation relative to the output image associated with the input image.

Steps 504-508 are performed on each input image in the batch.

The system generates a latent representation of the input image by using the encoder neural network (step 504).

The system generates a noisy latent representation based on adding noise to the latent representation of the input image (step 506).

The system processes a diffusion input that includes the noisy latent representation and a text prompt using the diffusion neural network to generate a denoising output that specifies an estimated noise included in the noisy latent representation (step 508).

The system trains the diffusion neural network to determine an update to values of parameters of the diffusion neural network based on optimizing a fine-tuning objective function that evaluates, for each input image in the batch, a difference between (i) the estimated noise and (ii) the noise added to the latent representation (step 510).

The system can repeatedly perform iterations of the process 500 on different batches of input images to update the parameters of the diffusion neural network. The system can continue performing iterations of the process 500 until termination criteria for the training of the diffusion neural network have been satisfied, e.g., until the parameters have converged, until a threshold amount of wall clock time has elapsed, or until a threshold number of iterations of the process 500 have been performed.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a degraded image; and
generating a restored image from the degraded image, comprising:
initializing a latent representation of the restored image;
updating the latent representation of the restored image across a plurality of updating iterations, the updating comprising, at each of the plurality of updating iterations:
for each of a plurality of image restoration tasks, processing a diffusion input for the updating iteration that comprises (i) a current latent representation, (ii) a representation of the degraded image, and (iii) a corresponding text prompt for the image restoration task using a diffusion neural network to generate a denoising output for the updating iteration that corresponds to the image restoration task;
determining a combined denoising output for the updating iteration based on the denoising outputs generated by using the diffusion neural network that correspond respectively to the plurality of image restoration tasks; and
updating the current latent representation using the combined denoising output; and
generating the restored image from an updated latent representation that is generated in a last updating iteration.

2. The method of claim 1, wherein the plurality of image restoration tasks comprise two or more of: a super resolution task, a motion deblur task, a defocus deblur task, or a denoise task.

3. The method of claim 1, wherein for each of the plurality of image restoration tasks, the corresponding text prompt for the image restoration task comprises:
a description of the image restoration task in natural language text, or
an identifier of the image restoration task.

4. The method of claim 1, wherein updating the current latent representation using the combined denoising output comprises:
for each of the plurality of image restoration tasks, generating two combined denoising outputs for the updating iteration; and
generating the updated latent representation based on the two combined denoising outputs.

5. The method of claim 1, wherein updating the current latent representation using the combined denoising output comprises:
applying a diffusion sampler to the combined denoising output.

6. The method of claim 1, wherein determining the combined denoising output for the updating iteration comprises:
determining the combined denoising output based on determining a weighted combination of the denoising outputs, wherein for each of the plurality of image restoration tasks, the denoising output that corresponds to the image restoration task is weighted in the weighted combination by a weight that is associated with the image restoration task.

7. The method of claim 6, wherein determining the weighted combination of the different denoising outputs comprises:
receiving a user input that, for each of the plurality of image restoration tasks, defines the weight that is associated the image restoration task.

8. The method of claim 6, wherein determining the weighted combination of the different denoising outputs comprises:
processing each of a plurality of initial restored images generated from the degraded image using an image quality assessment model to generate a quality score for the initial restored image; and
determining the weights associated with the plurality of image restoration tasks based on the quality scores.

9. The method of claim 1, wherein:
at a first updating iteration in the plurality of updating iterations, the current latent representation is the latent representation; and
at each subsequent updating iteration in the plurality of updating iterations, the current latent representation is an updated latent representation generated in a preceding updating iteration.

10. The method of claim 1, wherein the representation of the degraded image is generated by using an encoder neural network based on processing the degraded image.

11. The method of claim 1, wherein generating the restored image from the updated latent representation generated in the last updating iteration comprises:
processing the updated latent representation using a decoder neural network.

12. The method of claim 1, wherein updating the current latent representation using the combined denoising output comprises updating the current latent representation using classifier-free guidance.

13. A method performed by one or more computers to train a diffusion neural network, the method comprising:
obtaining a batch of input images from a plurality of training datasets that correspond respectively to a plurality of image restoration tasks, wherein, for each of the plurality of image restoration tasks, the training dataset that corresponds to the image restoration task comprises a plurality of input images and an output image associated with each of the plurality of input images, each input image having an image restoration task-specific degradation relative to the output image associated with the input image;
for each input image in the batch:
generating a latent representation of the input image;
generating a noisy latent representation based on adding noise to the latent representation of the input image;
processing a diffusion input that comprises the noisy latent representation using the diffusion neural network to generate a denoising output that specifies an estimated noise included in the noisy latent representation; and
determining an update to values of parameters of the diffusion neural network based on optimizing a fine-tuning objective function that evaluates, for each input image in the batch, a difference between (i) the estimated noise and (ii) the noise added to the latent representation.

14. The method of claim 13, wherein for each input image in the batch, the diffusion input comprises a text prompt for an image restoration task.

15. The method of claim 13, wherein adding the noise to the latent representation comprises generating the noise based on a given time step.

16. A system comprising one or more computers and one or more storage devices storing instructions that when executed by the one or more computers cause the one or more computers to perform operations comprising:
receiving a degraded image; and
generating a restored image from the degraded image, comprising:
initializing a latent representation of the restored image;
updating the latent representation of the restored image across a plurality of updating iterations, the updating comprising, at each of the plurality of updating iterations:
for each of a plurality of image restoration tasks, processing a diffusion input for the updating iteration that comprises (i) a current latent representation, (ii) a representation of the degraded image, and (iii) a corresponding text prompt for the image restoration task using a diffusion neural network to generate a denoising output for the updating iteration that corresponds to the image restoration task;
determining a combined denoising output for the updating iteration based on the denoising outputs generated by using the diffusion neural network that correspond respectively to the plurality of image restoration tasks; and
updating the current latent representation using the combined denoising output; and
generating the restored image from an updated latent representation that is generated in a last updating iteration.

17. The system of claim 16, wherein the plurality of image restoration tasks comprise two or more of: a super resolution task, a motion deblur task, a defocus deblur task, or a denoise task.

18. The system of claim 16, wherein for each of the plurality of image restoration tasks, the corresponding text prompt for the image restoration task comprises:
a description of the image restoration task in natural language text, or
an identifier of the image restoration task.

19. The system of claim 16, wherein updating the current latent representation using the combined denoising output comprises:
for each of the plurality of image restoration tasks, generating two combined denoising outputs for the updating iteration; and
generating the updated latent representation based on the two combined denoising outputs.

20. The system of claim 16, wherein updating the current latent representation using the combined denoising output comprises:
applying a diffusion sampler to the combined denoising output.
